(19) United States
(12) Patent Application Publication
(10) Pub. No.: US 2025/0048019 A1
(43) Pub. Date: Feb. 6, 2025

(54) WEARABLE ELECTRONIC DEVICE COMPRISING SPEAKER

(71) Applicant: Samsung Electronics Co., Ltd., Suwon-si (KR)

(72) Inventors: Byeongmin LEE, Suwon-si (KR); Juhee CHANG, Suwon-si (KR); Kiwook HAN, Suwon-si (KR)

(21) Appl. No.: 18/785,513

(22) Filed: Jul. 26, 2024

Related U.S. Application Data
(63) Continuation of application No. PCT/KR2024/010711, filed on Jul. 24, 2024.

(30) Foreign Application Priority Data
Aug. 3, 2023 (KR) 10-2023-0101721
Sep. 11, 2023 (KR) 10-2023-0120404

(51) Int. Cl. H04R 1/10; H04R 1/04; H04R 1/08

(52) U.S. Cl. CPC H04R 1/1075; H04R 1/04; H04R 1/086; H04R 1/1016

(57) ABSTRACT

A wearable electronic device is provided. The wearable electronic device includes a housing, a port coupled to the housing and including a sound passage communicating with the outside of the housing, a speaker disposed in the housing and configured to generate sound toward the sound passage, and a microphone facing at least a portion of the speaker. The speaker includes an oscillation member facing the microphone and at least a portion of the oscillation member is formed curved in a direction away from the microphone.

### CROSS-REFERENCE TO RELATED APPLICATION(S)

This application is a continuation application, claiming priority under § 365 (c), of an International application No. PCT/KR2024/010711, filed on Jul. 24, 2024, which is based on and claims the benefit of a Korean patent application number 10-2023-0101721, filed on Aug. 3, 2023, in the Korean Intellectual Property Office, and of a Korean patent application number 10-2023-0120404, filed on Sep. 11, 2023, in the Korean Intellectual Property Office, the disclosure of each of which is incorporated by reference herein in its entirety.

### TECHNICAL FIELD

The disclosure relates to a wearable electronic device. More particularly, the disclosure relates to a wearable electronic device including a microphone and a speaker.

### BACKGROUND ART

With the development of electronic technology, various types of wearable electronic devices are required to be miniaturized and to be provided with various functions. In order to meet these requirements, various electronic components are mounted on a printed circuit board (PCB).

One or more sound effect-related components may be mounted on a printed circuit board of a wearable electronic device. The sound effect-related components may include, for example, a speaker and a microphone, and these components may be placed inside the housing of the wearable electronic device with various shapes and arrangements corresponding to the exterior design of the wearable electronic device that is designed in various ways.

The wearable electronic device provided with the speaker and the microphone may include, for example, an in-ear earphone (or an earset, a headphone, or a headset) or a hearing aid. The wearable electronic device may be worn near a user's ear and may be manufactured in a compact size for this purpose.

The above information is presented as background information only to assist in an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide a wearable electronic device including a microphone and a speaker.

Additional aspects will be set forth in part in the description which follows and, in part, will be apparent from the description, or may be learned by practice of the presented embodiments.

In accordance with an aspect of the disclosure, a wearable electronic device is provided. The wearable device includes a housing, a port coupled to the housing and including a sound passage communicating with the outside of the housing, a speaker disposed inside the housing and configured to output sound toward the sound passage, and a microphone disposed to face at least a portion of the speaker. The speaker includes an oscillation member facing the microphone and at least partially curved in a direction away from the microphone.

The oscillation member may include a first oscillation member spaced apart from the microphone and curved in a direction away from the microphone, and a second oscillation member extending along the circumference of the first oscillation member and disposed to surround at least a portion of the microphone.

In accordance with another aspect of the disclosure, a wearable electronic device is provided. The wearable electronic device includes a housing, a port coupled to the housing and including a sound passage communicating with an outside of the housing, a speaker disposed in the housing and configured to output sound toward the sound passage, and a microphone disposed to face at least a portion of the speaker. The speaker includes an oscillation member comprising a first oscillation member spaced apart from the microphone and curved in a direction away from the microphone and a second oscillation member extending along a circumference of the first oscillation member and disposed to surround at least a portion of the microphone.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an audio module according to an embodiment of the disclosure;

FIG. 3 is a view illustrating a wearable electronic device according to an embodiment of the disclosure;

FIG. 4 is a side view illustrating a wearable electronic device according to an embodiment of the disclosure;

FIG. 5 is a portion of a cross-sectional view of a wearable electronic device according to an embodiment of the disclosure;

FIG. 6 is a portion of a cross-sectional view of a wearable electronic device according to an embodiment of the disclosure;

FIG. 7 is an exploded view a speaker according to an embodiment of the disclosure;

FIG. 8A is a portion of a cross-sectional view of a wearable electronic device according to an embodiment of the disclosure;

FIG. 8B is a portion of a cross-sectional view of a wearable electronic device according to an embodiment of the disclosure;

FIG. 9 is a portion of a cross-sectional view of a wearable electronic device according to an embodiment of the disclosure;

FIG. 10A is a graph illustrating the effect of a wearable electronic device according to an embodiment of the disclosure; and

FIG. 10B is a graph illustrating the effect of a wearable electronic device according to an embodiment of the disclosure.

Throughout the drawings, it should be noted that like reference numbers are used to depict the same or similar elements, features, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It should be understood that the singular form “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

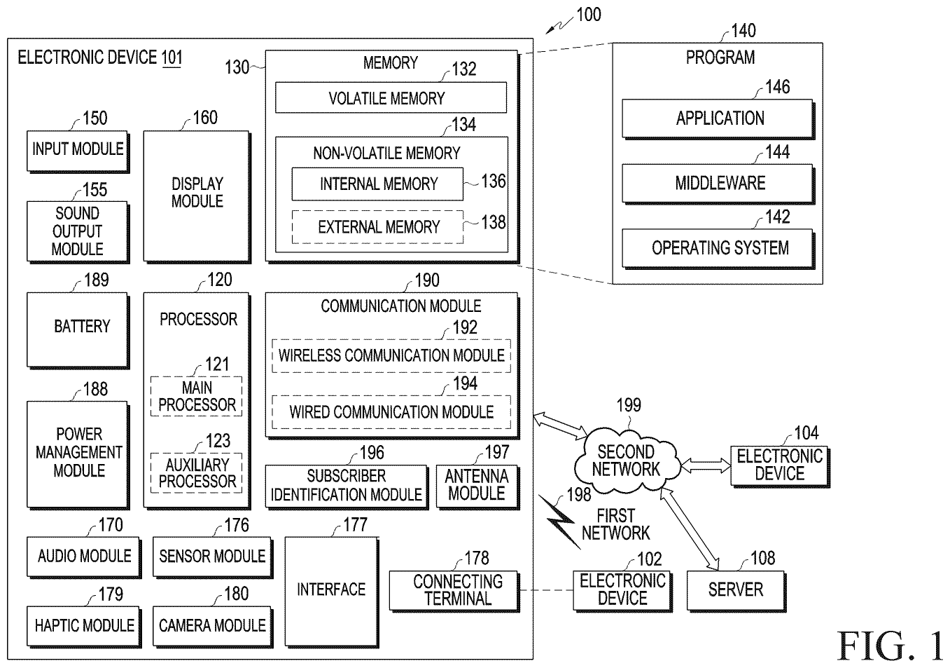

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module may include an antenna including a radiating element composed of a conductive material or a conductive pattern formed in or on a substrate (e.g., a printed circuit board (PCB)). According to an embodiment, the antenna module may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

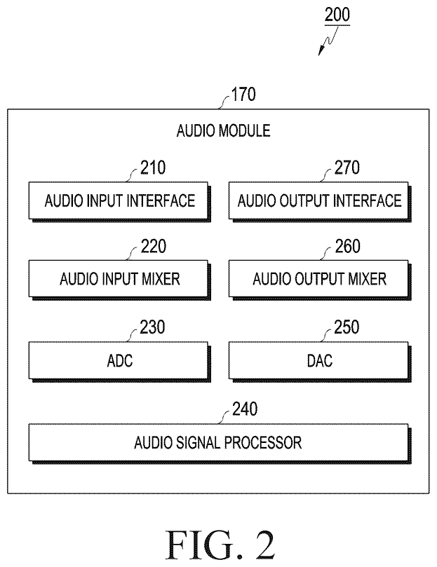

FIG. 2 is a block diagram 200 illustrating the audio module 170 according to an embodiment of the disclosure.

Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor (120) or the memory (l30)) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

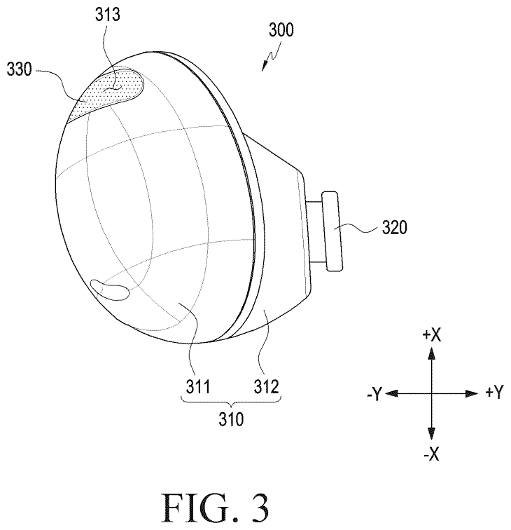

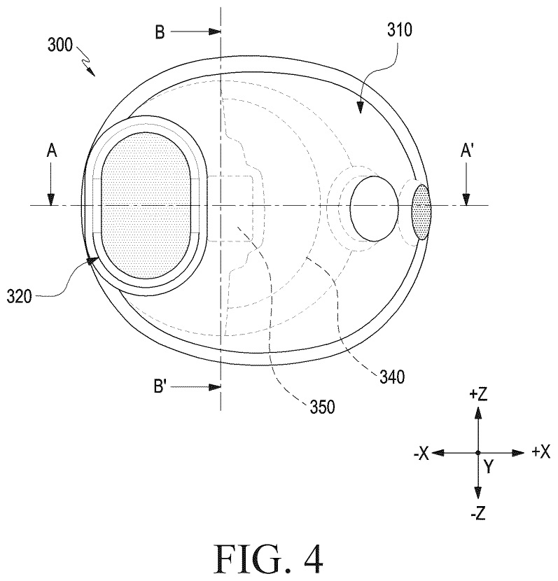

FIG. 3 is a view illustrating a wearable electronic device 300 according to an embodiment of the disclosure. FIG. 4 is a side view illustrating a wearable electronic device according to an embodiment of the disclosure.

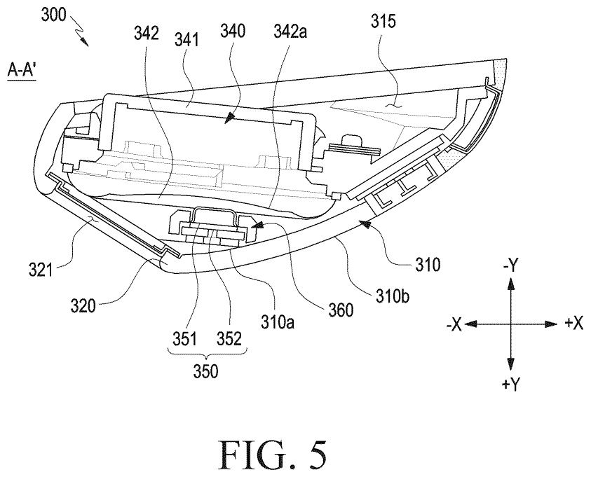

FIG. 4 is a view of the wearable electronic device 300 of FIG. 3 obtained when viewed from one direction (e.g., +Y direction) to the other direction (e.g., −Y direction). The components to be described with reference to FIGS. 3 and 4 may be partly or wholly the same as the components described with reference to FIGS. 1 to 2. The components to be described with reference to FIGS. 3 and 4 may be partly or wholly the same as the components to be described with reference to FIGS. 5 to 7, 8A and 8B, 9, and 10A and 10B.

According to an embodiment, the wearable electronic device 300 may include a housing 310. A space may be provided inside the housing 310. The housing 310 may include a first housing 311 and a second housing 312. The first housing 311 and the second housing 312 may be configured integrally. A speaker 340 and a microphone 350 may be placed inside the housing 310.

According to an embodiment, the wearable electronic device 300 may include a port 320. The port 320 may be coupled to the housing 310. The port 320 may protrude to the outside of the housing 310. The port 320 may be coupled to a second housing 312. Sound generated from the speaker 340 may be transmitted to the outside of the housing 310 through the port 320.

According to an embodiment, the wearable electronic device 300 may include a grill 330. The grill 330 may be coupled to the housing 310. Sound outside the housing 310 may flow into the housing 310 through the grill 330. The housing 310 may include an opening 313, and the grill 330 may be disposed in the opening 313.

According to an embodiment, the wearable electronic device 300 may include a speaker 340. The speaker 340 may be placed inside the housing 310. The speaker 340 may output sound to the outside of the housing 310.

According to an embodiment, the wearable electronic device 300 may include a microphone 350. The microphone 350 may be placed inside the housing 310. The microphone 350 may pick up sound generated outside the housing 310.

FIG. 5 is a portion of a cross-sectional view of a wearable electronic device according to an embodiment of the disclosure.

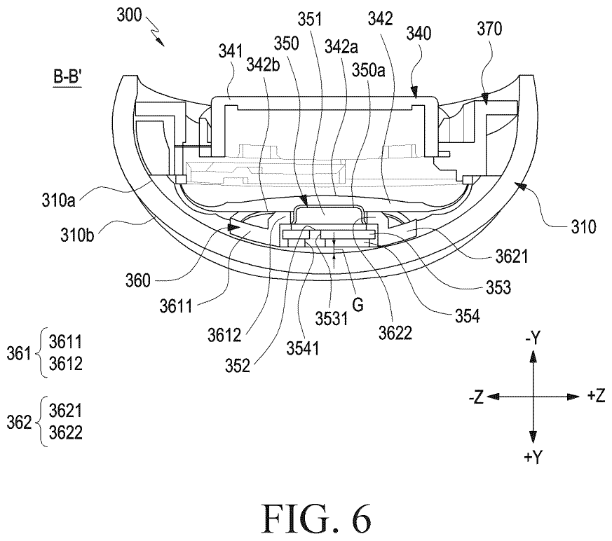

FIG. 5 is a cross-sectional view of the wearable electronic device 300 taken along reference line A-A′ illustrated in FIG. 4. The components to be described with reference to FIG. 5 may be partly or wholly the same as the components described with reference to FIGS. 1 to 4. The components to be described with reference to FIG. 5 may be partly or wholly the same as the components to be described with reference to FIGS. 6, 7, 8A, 8B, 9, 10A, and 10B.

According to an embodiment, the wearable electronic device 300 may include a housing 310 having a space 315 therein. The wearable electronic device 300 may include a port 320 coupled to the housing 310. A sound passage 321 may be provided inside the port 320. Sound generated from the speaker 340 may be transmitted to the outside of the housing 310 through the sound passage 321. Sound outside the housing 310 may be picked up by the microphone 350 through the sound passage 321.

According to an embodiment, the speaker 340 may be placed inside the housing 310. The speaker 340 may output sound toward the sound passage 321. The speaker 340 may include a speaker body 341. The speaker body 341 may define the external shape of the speaker 340. The speaker body 341 may be fixed inside the housing 310. The speaker 340 may include an oscillation member 342. The oscillation member 342 may be movably disposed in the speaker body 341. The oscillation member 342 may generate sound through oscillation.

According to an embodiment, the microphone 350 may be placed inside the housing 310. The microphone 350 may collect sound introduced through the sound passage 321. The microphone 350 may include a microphone body 351. The microphone body 351 may define the external shape of the microphone 350. The microphone 350 may include a microphone hole 352. The microphone hole 352 may be provided by being opened in the microphone body 351.

According to an embodiment, the housing 310 may include an inner surface 310a and an inner surface 310b. The inner surface 310a may face the inner space 315 of the housing 310. The microphone 350 may face the inner surface 310a of the housing 310. The microphone hole 352 may face the inner surface 310a.

According to an embodiment, the wearable electronic device 300 may include a rib 360. The rib 360 may be coupled to the housing 310. The rib 360 may protrude from the inner surface 310a of the housing 310. The rib 360 may support the microphone 350. At least a portion of the microphone 350 may be supported by the rib 360. The wearable electronic device 300 according to an embodiment of the disclosure may include a fastening member (not illustrated) that couples the microphone 350 and the housing 310. The microphone 350 may be fixed to the housing 310 by the fastening member (not illustrated). The wearable electronic device 300 according to an embodiment of the disclosure may include an adhesive member (not illustrated) disposed between the microphone 350 and the housing 310. The microphone 350 may be fixed to the housing 310 by the adhesive member (not illustrated).

According to an embodiment, the oscillation member 342 may include a first surface 342a. The first surface 342a may face the microphone 350. The first surface 342a may be curved in a direction away from the microphone 350. The first surface 342a may be formed concavely in a direction away from the microphone 350. The first surface 342a may be formed concavely from the second surface 342b. The first surface 342a may be formed convexly in a direction away from the microphone 350. The first surface 342a may be formed convexly from the second surface 342b. The above-mentioned terms “concavely” or “convexly” may be used differently depending on the direction in which the oscillation member 342 is viewed. For example, when the oscillation member 342 is viewed upward from one direction (e.g., the +Y direction) to the opposite direction (e.g., the −Y direction), it may be described that “the first surface 342a is formed convexly”. For example, when the oscillation member 342 is viewed downward from one direction (e.g., the +Y direction) to the opposite direction (e.g., the −Y direction), it may be described that “the first surface 342a is formed concavely”. The first surface 342a may be understood as a portion of a virtual ellipsoid surface. For example, the first surface 342a may be a portion of a virtual ellipsoid surface with a minor axis in the direction in which the speaker 340 and the microphone 350 are spaced apart from each other.

FIG. 6 is a portion of a cross-sectional view of a wearable electronic device according to an embodiment of the disclosure.

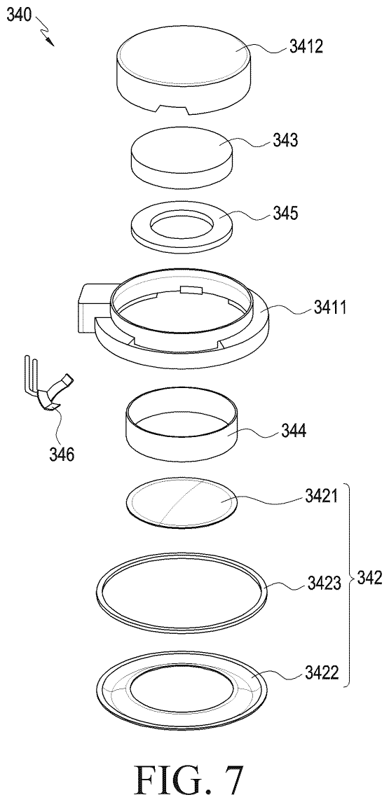

FIG. 6 is a cross-sectional view taken along reference line B-B′ illustrated in FIG. 4. The components to be described with reference to FIG. 6 may be partly or wholly the same as the components described with reference to FIGS. 1 to 5. The components to be described with reference to FIG. 6 may be partly or wholly the same as the components to be described with reference to FIGS. 7, 8A, 8B, 9, 10A and 10B.

According to an embodiment, the wearable electronic device 300 may include a support member 370. The support member 370 may be disposed inside the housing 310. The support member 370 may be fixed to the inner surface 310a of the housing 310. The speaker 340 may be fixed to the support member 370. At least a portion of the speaker 340 may be seated on the support member 370.

According to an embodiment, the oscillation member 342 may include a second surface 342b. The first surface 342a and the second surface 342b may be connected to each other. The second surface 342b may extend in the circumferential direction of the first surface 342a. The second surface 342b may be located below the first surface 342a (e.g., in the +Y direction). The second surface 342b may have an annular shape extending in the circumferential direction of the oscillation member 342.

According to an embodiment, the microphone 350 may include an end surface 350a. The end surface 350a may define the surface of microphone 350. The end surface 350a may be a surface of the microphone 350 that is opposite to the surface facing the inner surface 310a of the housing 310. The end surface 350a may face the first surface 342a. The end surface 350a may be located between the first surface 342a and the second surface 342b. At least a portion of the microphone 350 may pass through the space surrounded by the annular second surface 342b and protrude toward the first surface 342a. Due to the above-described structure, the volume of the space where the speaker 340 and the microphone 350 are placed inside the housing 310 may be reduced.

According to an embodiment, the microphone 350 may include a substrate 353. The substrate 353 may be coupled to the microphone body 351. The substrate 353 may be plate-shaped. The substrate 353 may be a rigid printed circuit board. The substrate 353 may be disposed between the microphone body 351 and the inner surface 310a. The substrate 353 may be disposed between the microphone body 351 and a shielding member 354. The substrate 353 may include a substrate hole 3531. The substrate hole 3531 may communicate with the microphone hole 352.

According to an embodiment, the microphone 350 may include the shielding member 354. The shielding member 354 may be coupled to the substrate 353. The shielding member 354 may be disposed between the substrate 353 and the inner surface 310a. The shielding member 354 may be referred to as a “waterproofing member”. The shielding member 354 may have a mesh shape. The shielding member 354 may include a shielding member hole 3541. The shielding member hole 3541 may communicate with the microphone hole 352. The microphone hole 352, the substrate hole 3531, and the shielding member hole 3541 may be in communication with each other.

According to an embodiment, the microphone 350 may be spaced apart from the inner surface 310a of the housing 310. A gap G may be formed between the bottom surface of the microphone 350 and the inner surface 310a. The shielding member 354 may be spaced apart from the inner surface 310a. The shielding member hole 3541 may be spaced apart from the inner surface 310a.

According to an embodiment, the rib 360 may include a first rib 361 and a second rib 362. The first rib 361 and the second rib 362 may be spaced apart from each other. The microphone 350 may be disposed between the first rib 361 and the second rib 362. At least a portion of the microphone 350 may be seated on each of the first rib 361 and the second rib 362. The first rib 361 and the second rib 362 may support at least portion of the microphone 350.

According to an embodiment, the first rib 361 may include a first coupling portion 3611 coupled to the housing 310. The first rib 361 protrudes from the first coupling portion 3611 and may include a first protrusion 3612 on which at least a portion of the microphone 350 is caught. The second rib 362 may include a second coupling portion 3621 coupled to the housing 310. The second rib 362 protrudes from the second coupling portion 3621 and may include a second protrusion 3622 on which at least a portion of the microphone 350 is caught.

FIG. 7 is an exploded view a speaker according to an embodiment of the disclosure.

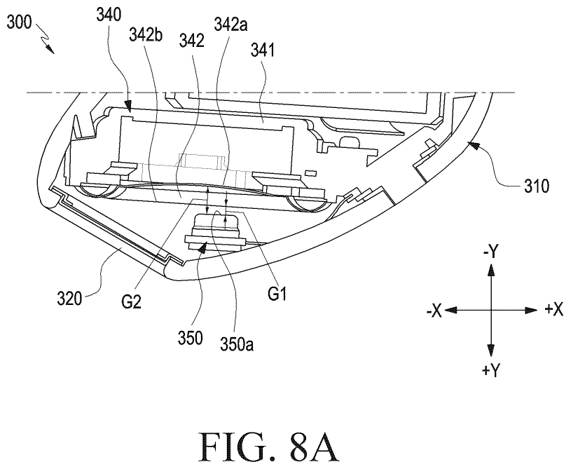

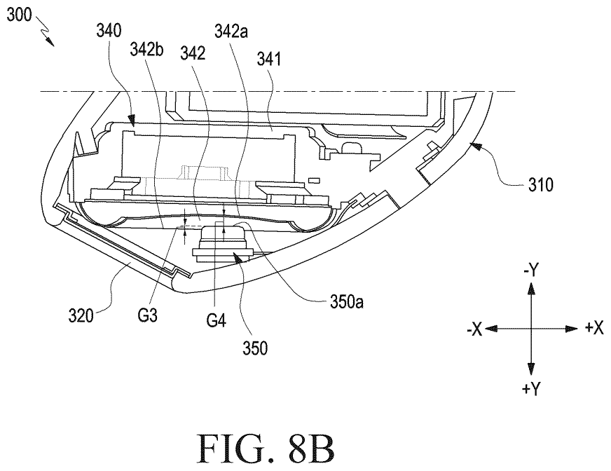

FIG. 7 is an exploded perspective view of the speaker 340. The components to be described with reference to FIG. 7 may be partly or wholly the same as the components described with reference to FIGS. 1 to 6. The components to be described with reference to FIG. 7 may be partly or wholly the same as the components to be described with reference to FIGS. 8A, 8B, 9, 10A, and 10B.

According to an embodiment, the speaker 340 may include a frame 3411. The oscillation member 342 may be coupled to the frame 3411. The speaker 340 may include a cap 3412. The cap 3412 may be coupled to the frame 3411. The oscillation member 342 may be coupled to one side of the frame 3411, and the cap 3412 may be coupled to the other side of the frame 3411. A space may be defined between the cap 3412 and the oscillation member 342. A space may be defined inside the frame 3411.

According to an embodiment, the speaker 340 may include a magnet 343, a coil 344, a plate 345, and a holder 346. The magnet 343, the coil 344, and the plate 345 may be disposed between the cap 3412 and the oscillation member 342. The magnet 343 may be seated on the plate 345. The plate 345 may be placed inside the frame 3411. The holder 346 may couple the plate 345 and the frame 3411. Current may be applied to the coil 344. The oscillation member 342 may oscillate by an electromagnetic field formed by the coil 344 to which current is applied and the magnet 343.

According to an embodiment, the oscillation member 342 may include a first oscillation member 3421, a second oscillation member 3422, and a third oscillation member 3423. The first oscillation member 3421, the second oscillation member 3422, and the third oscillation member 3423 may be assembled together. The third oscillation member 3423 may be disposed between the first oscillation member 3421 and the second oscillation member 3422. The third oscillation member 3423 may have a ring shape. The first oscillation member 3421 (e.g., a center diaphragm) may have a shape concave toward the cap 3412. The first oscillation member 3421 may be understood as a virtual ellipsoid surface. The first oscillation member 3421 may form the first surface 342a of the oscillation member 342 described with reference to FIG. 6. The first oscillation member 3421 may face the end surface 350a of the microphone 350 illustrated in FIG. 6. The second oscillation member 3422 (e.g., a side diaphragm) may extend in the circumferential direction of the first oscillation member 3421. The second oscillation member 3422 may have an annular shape. The second oscillation member 3422 may form the second surface 342b of the oscillation member 342 described with reference to FIG. 6. At least a portion of the microphone 350 illustrated in FIG. 6 may be disposed in a space surrounded by the second oscillation member 3422. The end surface 350a of the microphone 350 illustrated in FIG. 6 may be located between the first oscillation member 3421 and the second oscillation member 3422.

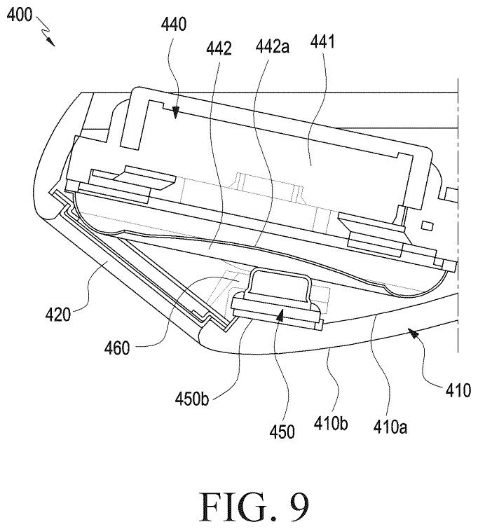

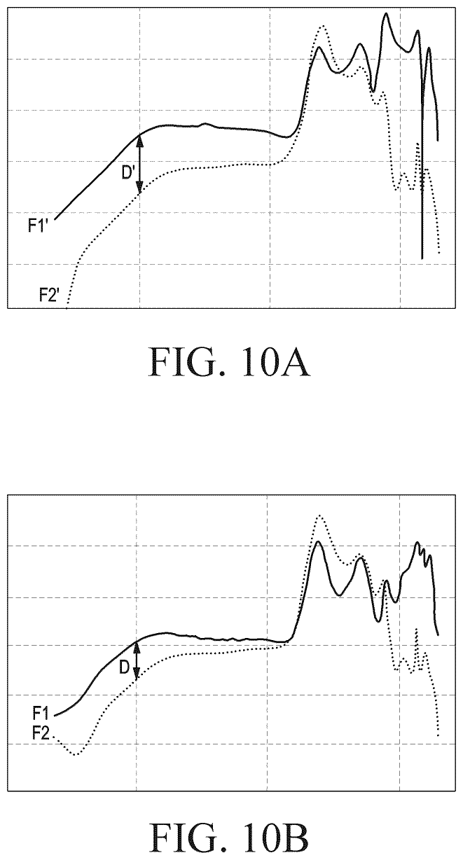

FIG. 8A is a portion of a cross-sectional view of a wearable electronic device according to an embodiment of the disclosure. FIG. 8A is a portion of a cross-sectional view of the wearable electronic device 300 in a first state in which the oscillation member 342 oscillates. FIG. 8B is a portion of a cross-sectional view of the wearable electronic device according to an embodiment of the disclosure. FIG. 8B is a portion of a cross-sectional view of the wearable electronic device 300 in a second state in which the oscillation member 342 oscillates. The components to be described with reference to FIGS. 8A and 8B may be partly or wholly the same as the components described with reference to FIGS. 1 to 7. The components to be described with reference to FIGS. 8A and 8B may be partially or entirely the same as the components to be described with reference to FIGS. 9, 10A, and 10B.

According to an embodiment, the oscillation member 342 may oscillate. The oscillation member 342 may oscillate along a first direction (e.g., the +Y direction) or a second direction (e.g., the −Y direction). The oscillation member 342 may oscillate in a direction away from the microphone 350 (e.g., the −Y direction) or in a direction closer to the microphone 350 (e.g., the +Y direction). When the oscillation member 342 oscillates, the distances (e.g., G2 and G4) between the first oscillation member (e.g., the first oscillation member 3421 in FIG. 7) and the microphone 350 may vary. When the oscillation member 342 oscillates, the distances (e.g., G1 and G3) between the second oscillation member (e.g., the second oscillation member 3422 in FIG. 7) and the microphone 350 may vary.

According to an embodiment, when the oscillation member 342 oscillates, the oscillation member 342 may be in the first state or the second state. The first state may be the state in which the distance (e.g., G1) between the second surface 342b and the end surface 350a is maximized, as illustrated in FIG. 8A. The first state may be the state in which the second surface 342b is located above the end surface 350a, as illustrated in FIG. 8A. The first state may be the state in which the distance between the first surface 342a and the end surface 350a is maximized, as illustrated in FIG. 8A. The second state may be the state in which the second surface 342b is located below the end surface 350a and the distance (e.g., G3) between the second surface 342b and the end surface 350a is minimized, as illustrated in FIG. 8B. The second state may be the state in which the distance between the first surface 342a and the end surface 350a is minimized, as illustrated in FIG. 8B.

According to an embodiment, in the first state, the first surface 342a and the end surface 350a may be spaced apart from each other. In the first state, the second surface 342b may be located above the end surface 350a. The distance G2 may be formed between the first surface 342a and the end surface 350a. The distance G2 between the first surface 342a and the end surface 350a may be larger than the distance G1 between the second surface 342b and the end surface 350a. In the first state, the distance G1 between the second surface 342b and the end surface 350a may be within a range of about 0.33 mm to about 0.34 mm. For example, the distance G1 may be 0.3398 mm.

According to an embodiment, in the second state, the first surface 342a and the end surface 350a may be spaced apart from each other. In the second state, the second surface 342b may be located below the end surface 350a. The distance G4 may be formed between the first surface 342a and the end surface 350a. In the second state, the distance G3 between the second surface 342b and the end surface 350a may be within a range of about 0.16 mm to about 0.17 mm. The distance G3 may be 0.1628 mm.

FIG. 9 is a portion of a cross-sectional view of a wearable electronic device 400 according to an embodiment of the disclosure. The components to be described with reference to FIG. 9 may be partly or wholly the same as the components described with reference to FIGS. 1 to 7, 8A, and 8B. The components to be described with reference to FIG. 9 may be partly or wholly the same as the components to be described with reference to FIGS. 10A and 10B.

According to an embodiment, the wearable electronic device 400 may include a housing 410, a port 420, and a speaker 440. The description of the components (e.g., the housing 310, the port 320, and the speaker 340) described with reference to FIGS. 1 to 7, 8A, and 8B) may be equally applicable to the above-described components (e.g., housing 410, port 420, and speaker 440). For example, the housing 410 may include an inner surface 410a and an outer surface 410b, and the speaker 440 may transmit sound to the outside of the housing 410 through the port 420. For example, the speaker 440 may include a speaker body 441 and an oscillation member 442, and the oscillation member 442 may include a first surface 442a curved in a direction away from the microphone 450.

According to an embodiment, the wearable electronic device 400 may include the microphone 450. The microphone 450 may be disposed between the speaker 440 and the housing 410. The microphone 450 may include a bottom surface 450b that is in contact with the inner surface 410a of the housing 410. The wearable electronic device 400 may include a rib 460 that fixes the microphone 450 to the housing 410. The rib 460 may protrude from the inner surface 410a of the housing 410.

FIG. 10A is a graph illustrating the effect of a wearable electronic device according to an embodiment of the disclosure. FIG. 10A is a graph illustrating the sound pickup performance of the microphone of the wearable electronic device according to the comparative example. FIG. 10B is a graph illustrating the effect of a wearable electronic device according to an embodiment of the disclosure. FIG. 10B is a graph showing the sound pickup performance of the microphone 350 of the wearable electronic device 300 (e.g., the microphone 350 in FIGS. 4 to 7, 8A, and 8B) according to an embodiment of the disclosure. The components to be described with reference to FIGS. 10A and 10B may be partially or entirely the same as the components described with reference to FIGS. 1 to 7, 8A, 8B, and 9.

According to the comparative example, the actual noise (F1′) generated outside the housing and the noise (F2′) picked up through the microphone may be identified. The comparative example may be an example in which the distance between the microphone and the speaker is larger than the distance (e.g., distances (G1, G2, G3, and G4) in FIGS. 8A and 8B) according to the embodiments of the disclosure. The horizontal axis represents a frequency band, and the vertical axis represents decibels (dB). In a predetermined frequency band (e.g., 20 Hz to 1 kHz), the dB difference D′ between the actual noise F1′ and the noise received through the microphone F2′ may be about 8.3 dB.

According to an embodiment of the disclosure (e.g., the wearable electronic device 300 in FIGS. 3 to 7, 8A, and 8B), the actual noise F1 generated outside the housing 310 and the noise F2 picked up through the microphone 350 may be identified. The horizontal axis represents a frequency band, and the vertical axis represents dB. In a predetermined frequency band (e.g., 20 Hz to 1 kHz), the dB difference D between the actual noise F1 and the noise F2 received through the microphone 350 may be about 3.3 dB, which is a reduced value compared to the comparative example. In a wearable electronic device (e.g., the wearable electronic device 300 or 400 in FIGS. 3 to 7, 8A, 8B, and 9) according to various embodiments of the disclosure, by reducing the distance between the microphone 350 and the speaker 340, it is possible to reduce the space occupied by the microphone 350 and the speaker 340 inside the housing 310 and to reduce the difference between the noise actually generated and the noise picked up through the microphone so that active noise cancellation (ANC) performance can be improved.

The wearable electronic device includes a housing that accommodates a speaker and a microphone. The speaker is disposed inside the housing and outputs sound to the outside of the housing. The microphone is disposed inside the housing to be spaced apart from the speaker, and implements an active noise cancellation (ANC) function by collecting sound from outside the housing. As wearable electronic devices become smaller, there is a need to reduce the space occupied by a speaker and a microphone inside the housing. In order to improve the ANC function of wearable electronic devices, it is necessary to reduce the distance from the microphone to the outside of the housing.

The problem to be solved in the disclosure may be to reduce the space occupied by the speaker and microphone inside the housing.

The problem to be solved in the disclosure may be to improve the active noise cancellation (ANC) function of the microphone.

The problems to be solved in the disclosure are not limited to the above-mentioned problems and may expand in various ways without departing from the spirit and scope of the disclosure.

In the electronic device according to various embodiments of the disclosure, the space occupied by the speaker and microphone within the housing can be reduced by disposing the microphone to face the concave surface of the oscillation member.

In the electronic device according to various embodiments of the disclosure, the active noise cancellation (ANC) function of the microphone can be improved by placing the microphone adjacent to a port in which a sound passage path facing the outside of the housing is formed.

Effects of the disclosure are not limited to the foregoing, and other unmentioned effects would be apparent to one of ordinary skill in the art from the following description.

A wearable electronic device (e.g., 300 in FIGS. 1 to 7, 8A, 8B, 9, 10A, and 10B) according to an embodiment of the disclosure may include a housing (e.g., 310 in FIGS. 1 to 7, 8A, 8B, 9, 10A, and 10B).

The wearable electronic device (e.g., 300 in FIGS. 1 to 7, 8A, 8B, 9, 10A, and 10B) according to an embodiment of the disclosure may include a port (e.g., 320 in FIGS. 1 to 7, 8A, 8B, 9, 10A, and 10B) coupled to the housing (e.g., 310 in FIGS. 1 to 7, 8A, 8B, 9, 10A, and 10B), and including a sound passage (e.g., 321 in FIGS. 1 to 10b) communicating with the outside of the housing (e.g., 310 in FIGS. 1 to 7, 8A, 8B, 9, 10A, and 10B).

The wearable electronic device (e.g., 300 in FIGS. 1 to 7, 8A, 8B, 9, 10A, and 10B) according to an embodiment of the disclosure may include a speaker (e.g., 340 in FIGS. 1 to 7, 8A, 8B, 9, 10A, and 10B) disposed inside the housing (e.g., 310 in FIGS. 1 to 7, 8A, 8B, 9, 10A, and 10B) and configured to output sound toward the sound passage (e.g., 321 in FIGS. 1 to 7, 8A, 8B, 9, 10A, and 10B).

The wearable electronic device (e.g., 300 in FIGS. 1 to 7, 8A, 8B, 9, 10A, and 10B) according to an embodiment of the disclosure may include a microphone (e.g., 350 in FIGS. 1 to 7, 8A, 8B, 9, 10A, and 10B) disposed to face at least a portion of the speaker (e.g., 340 in FIGS. 1 to 7, 8A, 8B, 9, 10A, and 10B).

The speaker (e.g., 340 in FIGS. 1 to 7, 8A, 8B, 9, 10A, and 10B) according to an embodiment of the disclosure may include an oscillation member (e.g., 342 in FIGS. 1 to 7, 8A, 8B, 9, 10A, and 10B) facing the microphone (e.g., 350 in FIGS. 1 to 7, 8A, 8B, 9, 10A, and 10B) and at least partially curved in a direction away from the microphone (e.g., 350 in FIGS. 1 to 7, 8A, 8B, 9, 10A, and 10B).

At least a portion of the microphone (e.g., 350 in FIGS. 1 to 7, 8A, 8B, 9, 10A, and 10B) according to an embodiment of the disclosure may be located in the concave inner space of the oscillation member (e.g., 342 in FIGS. 1 to 7, 8A, 8B, 9, 10A, and 10B).

The oscillation member (e.g., 342 in FIGS. 1 to 7, 8A, 8B, 9, 10A, and 10B) according to an embodiment of the disclosure may include a first oscillation member (e.g., 3421 in FIGS. 1 to 7, 8A, 8B, 9, 10A, and 10B) facing the microphone (e.g., 350 in FIGS. 1 to 7, 8A, 8B, 9, 10A, and 10B).

The oscillation member (e.g., 342 in FIGS. 1 to 7, 8A, 8B, 9, 10A, and 10B) according to an embodiment of the disclosure may include a second oscillation member (e.g., 3422 in FIGS. 1 to 7, 8A, 8B, 9, 10A, and 10B) extending along the circumference of the first oscillation member (e.g., 3421 in FIGS. 1 to 7, 8A, 8B, 9, 10A, and 10B).

The second oscillation member (e.g., 3422 in FIGS. 1 to 7, 8A, 8B, 9, 10A, and 10B) according to an embodiment of the disclosure may be disposed to surround at least a portion of the microphone (e.g., 350 in FIGS. 1 to 7, 8A, 8B, 9, 10A, and 10B).

The first oscillation member (e.g., 3421 in FIGS. 1 to 7, 8A, 8B, 9, 10A, and 10B) according to an embodiment of the disclosure may be concave in a direction away from the microphone (e.g., 350 in FIGS. 1 to 7, 8A, 8B, 9, 10A, and 10B).

The first oscillation member (e.g., 3421 in FIGS. 1 to 7, 8A, 8B, 9, 10A, and 10B) according to an embodiment of the disclosure may include a first surface (e.g., 342a in FIGS. 1 to 7, 8A, 8B, 9, 10A, and 10B) spaced apart from the microphone (e.g., 350 in FIGS. 1 to 7, 8A, 8B, 9, 10A, and 10B) and formed to be concave in a direction in which the microphone (e.g., 350 in FIGS. 1 to 7, 8A, 8B, 9, 10A, and 10B) and the first oscillation member (e.g., 3421 in FIGS. 1 to 7, 8A, 8B, 9, 10A, and 10B) are spaced apart from each other.

The microphone (e.g., 350 in FIGS. 1 to 7, 8A, 8B, 9, 10A, and 10B) according to an embodiment of the disclosure may include an end surface (e.g., 350a in FIGS. 1 to 7, 8A, 8B, 9, 10A, and 10B) located between the first oscillation member (e.g., 3421 in FIGS. 1 to 7, 8A, 8B, 9, 10A, and 10B) and the second oscillation member (e.g., 3422 in FIGS. 1 to 7, 8A, 8B, 9, 10A, and 10B).

The oscillation member (e.g., 342 in FIGS. 1 to 7, 8A, 8B, 9, 10A, and 10B) according to an embodiment of the disclosure may oscillate in a first direction closer to the microphone (e.g., 350 in FIGS. 1 to 7, 8A, 8B, 9, 10A, and 10B) or a second direction away from the microphone (e.g., 350 in FIGS. 1 to 7, 8A, 8B, 9, 10A, and 10B).

The wearable electronic device (e.g., 300 in FIGS. 1 to 7, 8A, 8B, 9, 10A, and 10B) according to an embodiment of the disclosure may include a rib (e.g., 360 in FIGS. 1 to 7, 8A, 8B, 9, 10A, and 10B) configured to support the microphone (e.g., 350 in FIGS. 1 to 7, 8A, 8B, 9, 10A, and 10B).

The microphone (e.g., 350 in FIGS. 1 to 7, 8A, 8B, 9, 10A, and 10B) according to an embodiment of the disclosure may include a microphone body (e.g., 351 in FIGS. 1 to 7, 8A, 8B, 9, 10A, and 10B) facing the speaker (e.g., 340 in FIGS. 1 to 7, 8A, 8B, 9, 10A, and 10B).

The microphone (e.g., 350 in FIGS. 1 to 7, 8A, 8B, 9, 10A, and 10B) according to an embodiment of the disclosure may include a substrate (e.g., 353 in FIGS. 1 to 7, 8A, 8B, 9, 10A, and 10B) disposed between the microphone body (e.g., 351 in FIGS. 1 to 7, 8A, 8B, 9, 10A, and 10B) and the inner surface (e.g., 310a in FIGS. 1 to 7, 8A, 8B, 9, 10A, and 10B) of the housing (e.g., 310 in FIGS. 1 to 7, 8A, 8B, 9, 10A, and 10B).

The microphone (e.g., 350 in FIGS. 1 to 7, 8A, 8B, 9, 10A, and 10B) according to an embodiment of the disclosure may include a shielding member (e.g., 354 in FIGS. 1 to 7, 8A, 8B, 9, 10A, and 10B) disposed between the substrate (e.g., 353 in FIGS. 1 to 7, 8A, 8B, 9, 10A, and 10B) and the inner surface (e.g., 310a in FIGS. 1 to 7, 8A, 8B, 9, 10A, and 10B) of the housing (e.g., 310 in FIGS. 1 to 7, 8A, 8B, 9, 10A, and 10B).

The microphone (e.g., 350 in FIGS. 1 to 7, 8A, 8B, 9, 10A, and 10B) according to an embodiment of the disclosure may include a microphone hole (e.g., 352 in FIGS. 1 to 7, 8A, 8B, 9, 10A, and 10B) opening in the microphone body (e.g., 351 in FIGS. 1 to 7, 8A, 8B, 9, 10A, and 10B).

The substrate (e.g., 353 in FIGS. 1 to 7, 8A, 8B, 9, 10A, and 10B) according to an embodiment of the disclosure may include a substrate hole (e.g., 3531 in FIGS. 1 to 7, 8A, 8B, 9, 10A, and 10B) communicating with the microphone hole (e.g., 352 in FIGS. 1 to 7, 8A, 8B, 9, 10A, and 10B).

The shielding member (e.g., 354 in FIGS. 1 to 7, 8A, 8B, 9, 10A, and 10B) according to an embodiment of the disclosure may include a shielding member hole (e.g., 3541 in FIGS. 1 to 7, 8A, 8B, 9, 10A, and 10B) communicating with the substrate hole (e.g., 3531 in FIGS. 1 to 7, 8A, 8B, 9, 10A, and 10B).

The shielding member (e.g., 354 in FIGS. 1 to 7, 8A, 8B, 9, 10A, and 10B) according to an embodiment of the disclosure may be spaced apart from the inner surface (e.g., 310a in FIGS. 1 to 7, 8A, 8B, 9, 10A, and 10B) of the housing (e.g., 310 in FIGS. 1 to 7, 8A, 8B, 9, 10A, and 10B).

In a first state in which the oscillation member (e.g., 342 in FIGS. 1 to 7, 8A, 8B, 9, 10A, and 10B) according to an embodiment of the disclosure oscillates, the oscillation member (e.g., 342 in FIGS. 1 to 7, 8A, 8B, 9, 10A, and 10B) and the microphone (e.g., 350 in FIGS. 1 to 7, 8A, 8B, 9, 10A, and 10B) may be spaced apart from each other.

The oscillation member (e.g., 342 in FIGS. 1 to 7, 8A, 8B, 9, 10A, and 10B) according to an embodiment of the disclosure may include a first surface (e.g., 342a in FIGS. 1 to 7, 8A, 8B, 9, 10A, and 10B) that is concave in a direction away from the microphone (e.g., 350 in FIGS. 1 to 7, 8A, 8B, 9, 10A, and 10B).

The oscillation member (e.g., 342 in FIGS. 1 to 7, 8A, 8B, 9, 10A, and 10B) according to an embodiment of the disclosure may include a second surface (e.g., 342a in FIGS. 1 to 7, 8A, 8B, 9, 10A, and 10B) extending along the circumference of the first surface (e.g., 342a in FIGS. 1 to 7, 8A, 8B, 9, 10A, and 10B).

In the first state according to an embodiment of the disclosure, the distance (e.g., G2 in FIGS. 1 to 7, 8A, 8B, 9, 10A, and 10B) between the first surface (e.g., 342a in FIGS. 1 to 7, 8A, 8B, 9, 10A, and 10B) and the microphone (e.g., 350 in FIGS. 1 to 7, 8A, 8B, 9, 10A, and 10B) may be larger than the distance (e.g., G1 in FIGS. 1 to 7, 8A, 8B, 9, 10A, and 10B) between the second surface (e.g., 342b in FIGS. 1 to 7, 8A, 8B, 9, 10A, and 10B) and the microphone (e.g., 350 in FIGS. 1 to 7, 8A, 8B, 9, 10A, and 10B).

In a second state in which the oscillation member (e.g., 342 in FIGS. 1 to 7, 8A, 8B, 9, 10A, and 10B) according to an embodiment of the disclosure oscillates, the end surface (e.g., 350a in FIGS. 1 to 7, 8A, 8B, 9, 10A, and 10B) of the microphone (e.g., 350 in FIGS. 1 to 7, 8A, 8B, 9, 10A, and 10B) may be located between the first surface (e.g., 342a in FIGS. 1 to 7, 8A, 8B, 9, 10A, and 10B) and the second surface (e.g., 342b in FIGS. 1 to 7, 8A, 8B, 9, 10A, and 10B).

The microphone (e.g., 450 in FIGS. 1 to 7, 8A, 8B, 9, 10A, and 10B) according to an embodiment of the disclosure may be in contact with the inner surface (e.g., 410a in FIGS. 1 to 7, 8A, 8B, 9, 10A, and 10B) of the housing (e.g., 410 in FIGS. 1 to 7, 8A, 8B, 9, 10A, and 10B).

The speaker (e.g., 340 in FIGS. 1 to 7, 8A, 8B, 9, 10A, and 10B) according to an embodiment of the disclosure may include an oscillation member (e.g., 342 in FIGS. 1 to 7, 8A, 8B, 9, 10A, and 10B) including a first oscillation member (e.g., 3421 in FIGS. 1 to 7, 8A, 8B, 9, 10A, and 10B) spaced apart from the microphone (e.g., 350 in FIGS. 1 to 7, 8A, 8B, 9, 10A, and 10B) and curved in a direction away from the microphone (e.g., 350 in FIGS. 1 to 7, 8A, 8B, 9, 10A, and 10B) and a second oscillation member (e.g., 3422 in FIGS. 1 to 7, 8A, 8B, 9, 10A, and 10B) extending along the first oscillation member (e.g., 3421 in FIGS. 1 to 7, 8A, 8B, 9, 10A, and 10B) and disposed to surround at least a portion of the microphone (e.g., 350 in FIGS. 17, 8A, 8B, 9, 10A, and to 10B).

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a housing;
a port coupled to the housing and including a sound passage communicating with an outside of the housing;
a speaker disposed in the housing and configured to generate sound toward the sound passage; and
a microphone facing at least a portion of the speaker,
wherein the speaker comprises an oscillation member facing the microphone, and
wherein at least a portion of the oscillation member is formed curved in a direction away from the microphone.

2. The wearable electronic device of claim 1, wherein at least a portion of the microphone is located in a concave space of the oscillation member.

3. The wearable electronic device of claim 1,
wherein the oscillation member comprises:
a first oscillation member facing the microphone; and
a second oscillation member extending along a circumferential direction of the first oscillation member, and
wherein the second oscillation member is disposed around at least a portion of the microphone.

4. The wearable electronic device of claim 3, wherein the first oscillation member is formed concavely in a direction away from the microphone.

5. The wearable electronic device of claim 3, wherein the first oscillation member comprises a first surface spaced apart from the microphone and formed concavely in a direction in which the microphone and the first oscillation member are spaced apart from each other.

6. The wearable electronic device of claim 3, wherein the microphone comprises an end surface located between the first oscillation member and the second oscillation member.

7. The wearable electronic device of claim 1, wherein the oscillation member is oscillated in a first direction toward the microphone or in a second direction away from the microphone.

8. The wearable electronic device of claim 1, further comprising:
a rib configured to support the microphone.

9. The wearable electronic device of claim 1, wherein the microphone comprises:
a microphone body facing the speaker;
a circuit board disposed between the microphone body and an inner surface of the housing; and
a sealing member disposed between the circuit board and the inner surface of the housing.

10. The wearable electronic device of claim 9,
wherein the microphone comprises a microphone hole opened through the microphone body,
wherein the circuit board comprises a circuit board hole communicating with the microphone hole, and
wherein the sealing member comprises a sealing member hole communicating with the circuit board hole.

11. The wearable electronic device of claim 9, wherein the sealing member is spaced apart from the inner surface of the housing.

12. The wearable electronic device of claim 1, wherein, when in a first state in which the oscillation member is oscillating, the oscillation member and the microphone are spaced apart from each other.

13. The wearable electronic device of claim 12,
wherein the oscillation member comprises:
a first surface formed concavely in a direction away from the microphone; and
a second surface extending along a circumferential direction of the first surface, and
wherein when in the first state, a gap (G2) between the first surface and the microphone is greater than a gap (G1) between the second surface and the microphone.

14. The wearable electronic device of claim 1,
wherein the oscillation member comprises:
a first surface formed concavely in a direction away from the microphone; and
a second surface extending along a circumferential direction of the first surface, and
wherein, when in a second state in which the oscillation member is oscillating, an end surface of the microphone is located between the first surface and the second surface.

15. The wearable electronic device of claim 1, wherein the microphone is in contact with an inner surface of the housing.

16. A wearable electronic device comprising:
a housing;
a port coupled to the housing and comprising a sound passage communicating with an outside of the housing;
a speaker disposed in the housing and configured to output sound toward the sound passage; and
a microphone disposed to face at least a portion of the speaker,
wherein the speaker comprises an oscillation member comprising a first oscillation member spaced apart from the microphone and curved in a direction away from the microphone and a second oscillation member extending along a circumference of the first oscillation member and disposed to surround at least a portion of the microphone.

17. The wearable electronic device of claim 16, wherein at least a portion of the microphone is located in a concave inner space of the oscillation member.

18. The wearable electronic device of claim 16, wherein the first oscillation member is spaced apart from the microphone and comprises a first surface which is concave in a direction in which the microphone and the first oscillation member are spaced apart from each other.

19. The wearable electronic device of claim 16, wherein the microphone comprises an end surface located between the first oscillation member and the second oscillation member.

20. The wearable electronic device of claim 16, wherein the oscillation member oscillates in a first direction toward the microphone or in a second direction away from the microphone.

21. The wearable electronic device of claim 16,
wherein the housing comprises a microphone hole, and
wherein the microphone comprises a substrate and a shielding member disposed to face the microphone hole.

22. The wearable electronic device of claim 21,
wherein the substrate comprises a substrate hole,
wherein the shielding member comprises a mesh,
wherein the substrate is disposed to align the substrate hole with the microphone hole, and
wherein the shielding member is disposed between the substrate hole and the microphone hole.
